(19) United States
(12) Patent Application Publication
(10) Pub. No.: US 2010/0136276 A1
(43) Pub. Date: Jun. 3, 2010

(54) PRESSURE-SENSITIVE ADHESIVE LAYER-CARRYING TRANSPARENT CONDUCTIVE FILM AND METHOD FOR PRODUCTION THEREOF

(75) Inventors: Hidehiko Andou, Ibaraki-shi (JP); Hideo Sugawara, Ibaraki-shi (JP); Tomotake Nashiki, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/525,864

(22) PCT Filed: Feb. 28, 2008
(86) PCT No.: PCT/JP2008/053460

§ 371 Date: Aug. 14, 2009

(30) Foreign Application Priority Data
Mar. 2, 2007 (JP) 2007-052974

(51) Int. Cl. B32B 33/00; B32B 37/00

(52) U.S. Cl. 428/41.8; 428/40.1; 156/182

(57) ABSTRACT

An object of the invention is to provide a transparent conductive film having good processability and to provide a method for production thereof. The pressure-sensitive adhesive layer-carrying transparent conductive film of the invention comprises: an amorphous transparent conductive laminate comprising a transparent plastic film substrate and an amorphous transparent conductive thin film provided on one side of the transparent plastic film substrate; a pressure-sensitive adhesive layer; and a release film that is provided on another side of the transparent plastic film substrate with the pressure-sensitive adhesive layer interposed therebetween and comprises at least a film substrate, wherein the release film is thicker than the amorphous transparent conductive laminate, and a value obtained by subtracting the thermal shrinkage percentage of the release film in the MD direction from the thermal shrinkage percentage of the amorphous transparent conductive laminate in the MD direction is from −0.3% to 0.45%.

### TECHNICAL FIELD

The invention relates to a pressure-sensitive adhesive layer-carrying transparent conductive film and a method for production thereof. After an appropriate process, the pressure-sensitive adhesive layer-carrying transparent conductive film is used for a transparent electrode of an advanced display system such as a liquid crystal display or an electroluminescence display, a touch panel or the like. In addition, the pressure-sensitive adhesive layer-carrying transparent conductive film is also used for prevention of static charge of a transparent product or electromagnetic wave shielding and for liquid crystal dimming glass, a transparent heater or the like.

### DESCRIPTION OF THE RELATED ART

Concerning conventional transparent conductive thin film, the so-called conductive glass is well known, which includes a glass member and an indium oxide thin film formed thereon. Since the base member of the conductive glass is made of glass, however, it has low flexibility or workability and cannot preferably be used in some applications. In recent years, therefore, transparent conductive films using various types of plastic films such as polyethylene terephthalate films as their substrates have been used, because of their advantages such as good impact resistance and light weight as well as flexibility and workability.

When used, the transparent conductive film forms a transparent conductive laminate, which includes a transparent plastic film substrate, a transparent conductive thin film provided on one side of the transparent plastic film substrate, a pressure-sensitive adhesive layer, and a transparent substrate bonded to the other side of the transparent plastic film substrate with the pressure-sensitive adhesive layer interposed therebetween (Patent Literatures 1 and 2).

Patent literature 1: Japanese Patent Application Laid-Open (JP-A) No. 02-66809

Patent Literature 2: JP-A No. 02-129808

### DISCLOSURE OF INVENTION

### Problems to be Solved by the Invention

The transparent conductive film is expected to be used not only for touch panels but also for various other applications. When the transparent conductive film forms the transparent conductive laminate described above, however, it has low workability, so that it can hardly find sufficiently wide application.

When the transparent conductive film is used for an electrode or the like, it is often used in the form of a crystalline transparent conductive film. It is known that an amorphous transparent conductive film has better workability for etching or the like. In general, heat treatment is performed to convert such an amorphous state into a crystalline state. However, when the transparent conductive film is bonded to an adherend such as a liquid crystal panel or a touch panel and then heat-treated, the heat treatment may cause a defect in the object.

Considering the bonding process, it will be better to place a release film, in advance, on the transparent conductive film with a pressure-sensitive adhesive layer interposed therebetween than to additionally form a pressure-sensitive adhesive layer on the transparent conductive film after heat treatment.

On the other hand, the transparent conductive film has been required to be thin. However, a thin transparent conductive film can be easily curled by heat treatment. Therefore, there has been a demand for a pressure-sensitive adhesive layer-carrying transparent conductive film that is less likely to be curled by heat treatment.

An object of the invention is to provide a transparent conductive film having good processability and to provide a method for production thereof.

### Means for Solving the Problems

As a result of investigations to solve the problems, the inventors have completed the invention based on the finding that the object can be achieved using the structure described below.

Namely, the pressure-sensitive adhesive layer-carrying transparent conductive film of the present invention is a pressure-sensitive adhesive layer-carrying transparent conductive film, comprising: an amorphous transparent conductive laminate comprising a transparent plastic film substrate and an amorphous transparent conductive thin film provided on one side of the transparent plastic film substrate; a pressure-sensitive adhesive layer; and a release film that is provided on another side of the transparent plastic film substrate with the pressure-sensitive adhesive layer interposed therebetween and comprises at least a film substrate, wherein the release film is thicker than the amorphous transparent conductive laminate, and a value obtained by subtracting the thermal shrinkage percentage of the release film in the MD direction from the thermal shrinkage percentage of the amorphous transparent conductive laminate in the MD direction is from −0.3% to 0.45%.

As used herein, the term “MD direction” refers to a direction in which the in-plane retardation of each of the amorphous transparent conductive laminate and the release film reaches a maximum, when measured with KOBRA21-ADH (trade name) manufactured by Oji Scientific Instruments at 23° C. and a wavelength of 590 nm. The measurement of the amorphous transparent conductive laminate is performed on its transparent plastic film substrate side. The measurement of the release film is performed on its film substrate side.

As used herein, the term “thermal shrinkage percentage” refers to a value calculated by the following formula: thermal shrinkage percentage (%)={(L₁−L₂)/L₁}×100, wherein L₁ and L₂ are as defined below. A square sample 100 mm (L₁) long in the MD direction and 100 mm long in a direction perpendicular thereto (the TD direction) is obtained from each of the amorphous transparent conductive laminate and the release film. After the sample is heated at 140° C. for 1.5 hours, the length (L₂) of the sample in the MD direction is measured.

As used herein, the term “amorphous” means that when the surface of the transparent conductive thin film is observed with a field emission transmission electron microscope (FE-TEM), polygonal or elliptical crystals make up 50% or less (preferably 0 to 30%) of the whole surface area of the transparent conductive thin film.

In the above, it is preferable that the pressure-sensitive adhesive layer-carrying transparent conductive film further comprises at least one undercoat layer, wherein the amorphous transparent conductive thin film is provided on one side of the transparent plastic film substrate with the at least one undercoat layer interposed therebetween.

In the above, it is preferable that the amorphous transparent conductive thin film is made of a metal oxide comprising 90 to 99% by weight of indium oxide and 1 to 10% by weight of tin oxide.

In the above, it is preferable that the transparent plastic film substrate has a thickness of 10 to 40 μm, and the release film has a thickness of 50 to 100 μm.

In the above, it is preferable that the release film has a bending elastic modulus of 1,500 to 8,000 MPa.

In the above, it is preferable that the release film comprises a peeling layer and/or a layer for preventing oligomer migration on a side where the film substrate of the release film faces the pressure-sensitive adhesive layer.

In the above, it is preferable that the pressure-sensitive adhesive layer has a thickness of 5 to 50 μm.

In the above, it is preferable that the pressure-sensitive adhesive layer is an acrylic-based pressure-sensitive adhesive layer.

In the above, it is preferable that the film substrate of the release film and the transparent plastic film substrate are made of the same type of materials.

In the above, it is preferable that the pressure-sensitive adhesive layer-carrying transparent conductive film has a curl of 25 mm or less, after being heated at 140° C. for 1.5 hours.

In the above, it is preferable that the pressure-sensitive adhesive layer is used for bonding to any other substrate, after the release film is peeled.

In the above, it is preferable that the amorphous transparent conductive thin film is subjected to a crystallization process, and then the crystallized transparent conductive thin film is used for bonding to any other substrate with the pressure-sensitive adhesive layer peeled from the release film.

Also, the method for producing the pressure-sensitive adhesive layer-carrying transparent conductive film of the present invention is a method for producing the pressure-sensitive adhesive layer-carrying transparent conductive film, comprising the steps of: providing an amorphous transparent conductive laminate comprising a transparent plastic film substrate and an amorphous transparent conductive thin film provided on one side of the transparent plastic film substrate; and bonding a pressure-sensitive adhesive layer provided on a release film to another side of the transparent plastic film substrate in the amorphous transparent conductive laminate.

### BRIEF DESCRIPTION OF THE DRAWINGS

FIG. 1 is a cross-sectional view showing an example of the pressure-sensitive adhesive layer-carrying transparent conductive film of the invention.

FIG. 2 is a cross-sectional view showing an example of the pressure-sensitive adhesive layer-carrying transparent conductive film of the invention.

### DESCRIPTION OF THE SYMBOLS

1 transparent plastic film substrate
2 transparent conductive thin film (amorphous transparent conductive thin film)
3 pressure-sensitive adhesive layer
4 release film
5 undercoat layer
10 transparent conductive laminate (amorphous transparent conductive laminate)

### BEST MODES FOR CARRYING OUT THE INVENTION

The pressure-sensitive adhesive layer-carrying transparent conductive film of the invention includes a transparent plastic film substrate and an amorphous transparent conductive thin film provided on one side of the substrate. A crystalline transparent conductive thin film is generally used in transparent conductive films. In the invention, however, an amorphous transparent conductive thin film is used. The amorphous transparent conductive thin film has excellent processability compared to the crystalline transparent conductive thin film and therefore can widen the application range as the transparent conductive film.

The pressure-sensitive adhesive layer-carrying transparent conductive film also includes a pressure-sensitive adhesive layer provided on the other side of the transparent plastic film substrate and a release film provided on the pressure-sensitive adhesive layer. The pressure-sensitive adhesive layer covered with the release film can be easily turned into a surface layer by peeling off the release film. The pressure-sensitive adhesive layer, which can be bonded to any other substrate, has good processability and therefore can widen the application range as the transparent conductive film.

As mentioned above, the transparent conductive film of the invention uses the amorphous transparent conductive thin film as the transparent conductive thin film and the release film-covered pressure-sensitive adhesive layer placed to be a surface layer, so that it has dramatically improved processability and a significantly widened range of application. Specifically, the amorphous transparent conductive thin film may be etched regardless of before and after the bonding of the pressure-sensitive adhesive layer to any other substrate. In addition, the amorphous transparent conductive thin film may be crystallized by heat treatment, and then the pressure-sensitive adhesive layer may be bonded to any other substrate, which makes it possible to provide a crystallized transparent conductive thin film on a substrate vulnerable to heat treatment.

In some conventional techniques, a pressure-sensitive adhesive layer is provided on the other side of a transparent plastic film substrate in a transparent conductive film as disclosed in Patent Literature 1 or 2. In this case, the transparent conductive film is used in the form of a transparent conductive laminate, which includes a transparent substrate provided on the pressure-sensitive adhesive layer. That is, even when the conventional transparent conductive film has a pressure-sensitive adhesive layer, a transparent substrate is bonded to the pressure-sensitive adhesive layer. When the transparent conductive film (transparent conductive laminate) is used in a touch panel or the like, the side of the transparent plastic film substrate where no transparent conductive thin film is provided corresponds to the outer surface side of the transparent conductive film (transparent conductive laminate). According to the conventional techniques, therefore, it is hard to conceive that the pressure-sensitive adhesive layer can be provided on the outer surface, although a hard coat layer is provided on the outer surface in some cases as disclosed in Patent Literature 1. In conventional transparent conductive films, therefore, no release film is provided on the side of the transparent plastic film substrate where no transparent conductive thin film is provided, with a pressure-sensitive adhesive layer interposed between the release film and the substrate.

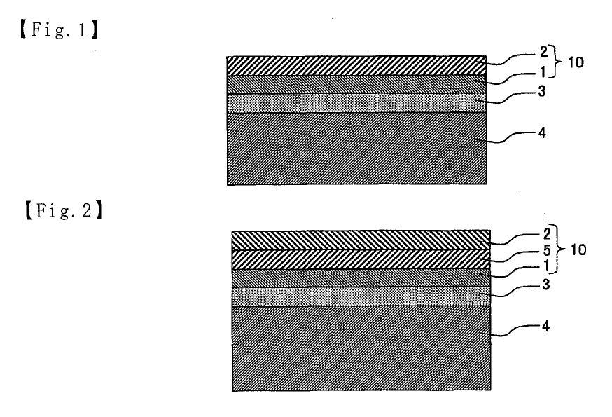

Embodiments of the invention are described below with reference to the drawings. FIG. 1 is a cross-sectional view showing an example of the pressure-sensitive adhesive layer-carrying transparent conductive film of the invention. In FIG. 1, the pressure-sensitive adhesive layer-carrying transparent conductive film includes: a transparent conductive laminate 10 including a transparent plastic film substrate 1 and a transparent conductive thin film 2 provided on one side of the transparent plastic film substrate 1; a pressure-sensitive adhesive layer 3; and a release film 4 provided on the other side of the transparent plastic film substrate 1 with the pressure-sensitive adhesive layer 3 interposed therebetween. FIG. 2 shows a modification of the pressure-sensitive adhesive layer-carrying transparent conductive film in FIG. 1, in which the transparent conductive thin film 2 is provided on one side of the transparent plastic film substrate 1 with an undercoat layer 5 interposed therebetween. While a single undercoat layer 5 is shown in FIG. 2, a plurality of undercoat layers 5 may be provided.

In the pressure-sensitive adhesive layer-carrying transparent conductive film of the invention, the release film 4 is thicker than the transparent conductive laminate 10. This feature makes it possible to improve the workability in the process of manufacturing the pressure-sensitive adhesive layer-carrying transparent conductive film and in the process of bonding it to an adherend and also makes it possible to reduce the thickness of the transparent conductive laminate 10.

In the pressure-sensitive adhesive layer-carrying transparent conductive film of the invention, a value obtained by subtracting the thermal shrinkage percentage of the release film 4 in the MD direction from the thermal shrinkage percentage of the transparent conductive laminate 10 in the MD direction is from −0.3 to 0.45% (preferably from −0.15 to 0.45%), so that the curl after heating at 140° C. for 1.5 hours as described later can be reduced to, for example, 25 mm or less, which makes it possible to produce a film with good processability, even when the transparent conductive laminate 10 is relatively thin.

The transparent plastic film substrate 1 to be used may be, but not limited to, various transparent plastic films. The plastic film is generally formed of a monolayer film. Examples of the material for the transparent plastic film substrate 1 include polyester resins such as polyethylene terephthalate and polyethylene naphthalate, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. In particular, polyester resins, polyimide resins, and polyethersulfone resins are preferred.

Examples thereof also include polymer films as disclosed in JP-A No. 2001-343529 (WO01/37007) and a resin composition that contains a thermoplastic resin having a side chain of a substituted and/or unsubstituted imide group and a thermoplastic resin having a side chain of substituted and/or unsubstituted phenyl and nitrile groups. Specifically, a polymer film of a resin composition containing an alternating copolymer made of isobutylene and N-methylmaleimide, and an acrylonitrile-styrene copolymer may be used.

The thickness of the transparent plastic film substrate 1 is preferably from 10 to 40 μm, more preferably from 20 to 30 μm. If the thickness of the transparent plastic film substrate 1 is less than 10 μm, the mechanical strength of the transparent plastic film substrate 1 may be insufficient, so that it may sometimes be difficult to perform the process of continuously forming the transparent conductive thin film 2 on the transparent plastic film substrate 1 being fed from a roll. On the other hand, if the thickness is more than 40 μm, the amount of introduction of the transparent plastic film substrate 1 may be reduced in the process of producing the transparent conductive thin film 2, and the process of removing gas or moisture may be hindered, so that the productivity may be reduced. In this case, it may also be difficult to reduce the thickness of the transparent conductive laminate 10.

The surface of the transparent plastic film substrate 1 may be previously subject to sputtering, corona discharge treatment, flame treatment, ultraviolet irradiation, electron beam irradiation, chemical treatment, etching treatment such as oxidation, or undercoating treatment such that the adhesion of the transparent conductive thin film 2 or the undercoat layer 5 formed thereon to the transparent plastic film substrate 1 can be improved. If necessary, the transparent plastic film substrate 1 may also be subjected to dust removing or cleaning by solvent cleaning, ultrasonic cleaning or the like, before the transparent conductive thin film 2 or the undercoat layer 5 is formed.

Examples of materials that are preferably used to form the transparent conductive thin film 2 include, but are not limited to, oxides such as tin oxide-doped indium oxide and antimony-doped tin oxide. In addition, the transparent conductive thin film 2 is amorphous. When any of the above materials are used to form the transparent conductive thin film 2, the transparent conductive thin film 2 can be made amorphous by controlling the content of tin oxide in the material (by adding tin oxide in a predetermined amount).

The transparent conductive thin film 2 is preferably made of tin oxide-doped indium oxide. When the amorphous transparent conductive thin film is made of such a metal oxide, the metal oxide preferably contains 90 to 99% by weight of indium oxide and 1 to 10% by weight of tin oxide, more preferably contains 95 to 98% by weight of indium oxide and 2 to 5% by weight of tin oxide.

The thickness of the transparent conductive thin film 2 is preferably, but not limited to, 10 nm or more, in order that it may form a highly-conductive continuous coating film with a surface resistance of 1×10³ Ω/square or less. If the thickness is too large, a reduction in transparency and so on may occur. Therefore, the thickness is preferably from 15 to 35 nm, more preferably from 20 to 30 nm. If the thickness is less than 15 nm, the surface electric resistance may be too high, and it may be difficult to form a continuous coating film. If the thickness is more than 35 nm, a reduction in transparency and so on may occur.

The transparent conductive thin film 2 may be formed using known conventional methods, while the methods are not particularly limited. Examples of such methods include vacuum deposition, sputtering, and ion plating. Any appropriate method may be used depending on the required film thickness.

The undercoat layer 5 may be made of an inorganic material, an organic material or a mixture of an inorganic material and an organic material. Examples of the inorganic material include NaF (1.3), Na₃AlF₆ (1.35), LiF (1.36), MgF₂ (1.38), CaF₂ (1.4), BaF₂ (1.3), SiO₂ (1.46), LaF₃ (1.55), CeF₃ (1.63), and Al₂O₃ (1.63), wherein each number inside the parentheses is the refractive index of each material. In particular, SiO₂, MgF₂, Al₂O₃, or the like is preferably used. In particular, SiO₂ is preferred. Besides the above, a complex oxide containing about 10 to about 40 parts by weight of cerium oxide and about 0 to about 20 parts by weight of tin oxide based on 100 parts by weight of the indium oxide may also be used.

The undercoat layer of an inorganic material may be formed by a dry process such as vacuum deposition, sputtering or ion plating, or a wet process such as coating. As described above, SiO₂ is preferably used as an inorganic material to form the undercoat layer. In a wet process, a silica sol or the like may be applied to form a SiO₂ film.

Examples of the organic material include acrylic resins, urethane resins, melamine resins, alkyd resins, siloxane polymers, and organosilane-based condensates. At least one of these organic materials may be used. In particular, a thermosetting resin including a mixture composed of a melamine resin, an alkyd resin and an organosilane condensate is preferably used as the organic material.

When a plurality of undercoat layers 5 are formed, the first undercoat layer from the transparent plastic film substrate 1 is preferably made of an organic material, and the undercoat layer most distant from the transparent plastic film substrate 1 is preferably made of an inorganic material, in view of the processability of the resulting pressure-sensitive adhesive layer-carrying transparent conductive film. When two undercoat layers 5 are formed, therefore, the first undercoat layer from the transparent plastic film substrate 1 is preferably made of an organic material, and the second undercoat layer is preferably made of an inorganic material.

The thickness of the undercoat layer 5 is generally, but not limited to, from about 1 to about 300 nm, preferably from 5 to 300 nm, in view of optical design and the effect of preventing the release of an oligomer from the transparent plastic film substrate 1. When two or more undercoat layers 5 are provided, the thickness of each layer may be from about 5 to about 250 nm, preferably from 10 to 250 nm.

The release film 4 is provided on the other side of the transparent plastic film substrate 1 provided with the transparent conductive thin film 2, and the pressure-sensitive adhesive layer 3 is interposed between the substrate 1 and the release film 4. In this structure, a layer for preventing oligomer migration is preferably provided between the transparent plastic film substrate 1 and the pressure-sensitive adhesive layer 3. Any appropriate material capable of forming a transparent film may be used to form the migration preventing layer, and such a material may be an inorganic or organic material or a composite of inorganic and organic materials. The thickness of the migration preventing layer is preferably from 0.01 to 20 μm. The migration preventing layer is often formed by a coating method using a coater, a spraying method, a spin coating method, an in-line coating method, or the like. However, any other technique such as vacuum deposition, sputtering, ion plating, spray thermal decomposition, chemical plating, or electroplating may also be used. The coating method may be performed using a resin component such as an acrylic-based resin, a urethane-based resin, a melamine-based resin, a UV-curable resin, or an epoxy-based resin, or a mixture of any of the above resins and inorganic particles of alumina, silica, mica, or the like. A laminated substrate may also be used, which is formed by coextrusion of two or more layers including the migration preventing layer. When the vacuum deposition, sputtering, ion plating, spray thermal decomposition, chemical plating, or electroplating method is used, a metal such as gold, silver, platinum, palladium, copper, aluminum, nickel, chromium, titanium, iron, cobalt, or tin, or any alloy thereof; a metal oxide such as indium oxide, tin oxide, titanium oxide, cadmium oxide, or any mixture thereof; or any other metal compounds such as metal iodides may be used.

Any transparent pressure-sensitive adhesive may be used for the pressure-sensitive adhesive layer 3 without limitation. For example, the pressure-sensitive adhesive may be appropriately selected from transparent adhesives based on polymers such as acrylic polymers, silicone polymers, polyester, polyurethane, polyamide, polyvinyl ether, vinyl acetate-vinyl chloride copolymers, modified polyolefins, epoxy polymers, fluoropolymers, and rubbers such as natural rubbers and synthetic rubbers. In particular, acrylic pressure-sensitive adhesives are preferably used, because they have good optical transparency and good weather or heat resistance and exhibit suitable wettability and adhesion properties such as cohesiveness and adhesiveness.

The anchoring force can be improved using an appropriate pressure-sensitive adhesive primer, depending on the type of the pressure-sensitive adhesive as a material for forming the pressure-sensitive adhesive layer 3. In the case of using such a pressure-sensitive adhesive, therefore, a certain pressure-sensitive adhesive primer is preferably used. The pressure-sensitive adhesive primer is generally provided on the transparent plastic film substrate 1 side.

The pressure-sensitive adhesive primer may be of any type as long as it can be a layer improving the anchoring force of the pressure-sensitive adhesive. Specific examples of the pressure-sensitive adhesive primer that may be used include so-called coupling agents such as a silane-based coupling agent having a reactive functional group such as an amino group, a vinyl group, an epoxy group, a mercapto group, or a chloro group and a hydrolyzable alkoxysilyl group in the same molecule, a titanate-based coupling agent having a titanium-containing hydrolyzable hydrophilic group and an organic functional group in the same molecule, and an aluminate-based coupling agent having an aluminum-containing hydrolyzable hydrophilic group and an organic functional group in the same molecule; and a resin having an organic reactive group, such as an epoxy-based resin, an isocyanate-based resin, a urethane-based resin, or an ester urethane-based resin. In particular, a silane coupling agent-containing layer is preferred, because it is easy to handle industrially.

The pressure-sensitive adhesive layer 3 may contain a crosslinking agent appropriate to the base polymer. If necessary, the pressure-sensitive adhesive layer 3 may also contain an appropriate additive such as a filler including natural or synthetic resin, glass fibers or beads, or metal powder or any other inorganic powder; a pigment, a colorant, or an antioxidant. The pressure-sensitive adhesive layer 3 may also contain transparent fine particles to have the ability to diffuse light.

Examples of the transparent fine particles that may be used include one or more types of appropriate electrically-conductive inorganic fine particles of silica, calcium oxide, alumina, titania, zirconia, tin oxide, indium oxide, cadmium oxide, antimony oxide, or the like with an average particle size of 0.5 to 20 μm and one or more types of appropriate crosslinked or uncrosslinked organic fine particles of an appropriate polymer such as poly(methyl methacrylate) or polyurethane with an average particle size of 0.5 to 20 μm.

The pressure-sensitive adhesive layer 3 is generally made from a pressure-sensitive adhesive solution (with a solids content of about 10 to about 50% by weight) containing a base polymer or a composition thereof dissolved or dispersed in a solvent. The solvent to be used may be appropriately selected from an organic solvent such as toluene or ethyl acetate or water or the like depending on the type of the pressure-sensitive adhesive.

After the pressure-sensitive adhesive layer-carrying transparent conductive film of the invention (the product obtained by peeling the release film) is bonded to various adherends, the pressure-sensitive adhesive layer 3 has a cushion effect and thus can function to improve the scratch resistance of the transparent conductive thin film formed on one side of the transparent plastic film substrate 1 or to improve the tap properties thereof for touch panels, such as so called pen input durability and surface pressure durability. From the viewpoints of exerting the function better, the elastic coefficient of the pressure-sensitive adhesive layer 3 is preferably set in the range of 1 to 100 N/cm² and its thickness should be set in the range of 5 to 50 μm, preferably in the range of 10 to 30 μm. When it has a thickness in the above range, the effect is sufficiently produced, so that the adhesiveness to the adherend can be sufficient. If the thickness is less than the range, a sufficient level of the durability or adhesion cannot be ensured. If the thickness is more than the range, the adhesive may squeeze out to cause chipping or degrade processability, so that the appearance such as transparency may be further degraded.

If the elastic coefficient is less than 1 N/cm², the pressure-sensitive adhesive layer 3 may be inelastic so that it may be easily deformed by pressing, which may cause irregularities in the transparent plastic film substrate 1 and then in the transparent conductive thin film 2. Further, the pressure-sensitive adhesive may also easily squeeze out of the cut section, and the effect of improving the scratch resistance of the transparent conductive thin film 2 or improving the tap properties of the thin film 2 for touch panels may be reduced. On the other hand, if the elastic coefficient is more than 100 N/cm², the pressure-sensitive adhesive layer 3 can be so hard that the cushion effect cannot be expected, which tends to make it difficult to improve the scratch resistance of the transparent conductive thin film 2 or the pen input durability of the thin film 2 for touch panels.

If the thickness of the pressure-sensitive adhesive layer 3 is less than 5 μm, the cushion effect cannot be expected so that it may tend to be difficult to improve the scratch resistance of the transparent conductive thin film 2 or the pen input durability of the thin film 2 for touch panels. On the other hand, if it is too thick, the transparency may be reduced, or it may be difficult to obtain good results in the process of the formation of the pressure-sensitive adhesive layer 3, in the process of the workability of the bonding to various adherends, and the cost.

The release film 4 includes at least a film substrate. Examples of materials for the film substrate include polyester-based resins such as polyethylene terephthalate and polyethylene naphthalate, polyolefin-based resins such as polypropylene, paper and the like. In particular, the film substrate is preferably made of polyethylene-based resins, polyolefin-based resins, or paper.

The release film 4 may further include a peeling layer and/or a layer for preventing oligomer migration, each of which is provided on a side where the film substrate of the release film faces the pressure-sensitive adhesive layer.

The peeling layer may be made of an appropriate peeling agent such as a silicone-based peeling agent, a long-chain alkyl-based peeling agent, a fluorine-based peeling agent, or molybdenum sulfide. The thickness of the peeling layer may be set as appropriate in view of the release effect. In general, the thickness is preferably 20 μm or less, more preferably in the range of 0.01 to 10 μm, particularly preferably in the range of 0.1 to 5 μm, in view of handleability such as flexibility. The peeling layer may be formed by any method such as coating, spraying, spin coating, or in-line coating. Vacuum deposition, sputtering, ion plating, spray thermal decomposition, chemical plating, electroplating, or the like may also be used.

When provided together with the peeling layer, the migration preventing layer is preferably placed between the peeling layer and the film substrate in the release film. The migration preventing layer may be made of an appropriate material for preventing migration of migrant components from the film substrate of the release film (such as a polyester film), particularly for preventing migration of low molecular weight oligomer components from a polyester. An inorganic or organic material or a composite of inorganic and organic materials may be used to form the migration preventing layer. The thickness of the migration preventing layer may be appropriately set in the range of 0.01 to 20 μm. When the layer for preventing oligomer migration is provided, the molar ratio of the oligomer to the main component in the pressure-sensitive adhesive layer can be suppressed to 0.2 or less. The molar ratio may be calculated by comparing the oligomer peak integration value and the pressure-sensitive adhesive peak integration value each measured by ¹H-NMR (analytical apparatus: JNM-EX400 manufactured by JEOL Ltd.; measurement solvent: CDCl₃).

The migration preventing layer may be formed by the same method as that for the peeling layer, while the method is not particularly limited. The coating, spraying, spin coating, or in-line coating method may be performed using an ionizing radiation-curable resin such as an acrylic-based resin, a urethane-based resin, a melamine-based resin, or an epoxy-based resin, or a mixture of any of the above resins and aluminum oxide, silicon dioxide, mica, or the like. Vacuum deposition, sputtering, ion plating, spray thermal decomposition, chemical plating, or electroplating may also be performed using an oxide of a metal such as gold, silver, platinum, palladium, copper, aluminum, nickel, chromium, titanium, iron, cobalt, or tin, an oxide of an alloy thereof, or any other metal compound such as a metal iodide.

The thickness of the release film 4 corresponds to the thickness of the film substrate or the total of the thicknesses of the film substrate and the peeling layer and/or the migration preventing layer, if any, and is preferably from 50 to 100 μm, more preferably from 60 to 85 μm. When the thickness is 50 μm or more, the workability can be improved in the process of manufacturing the pressure-sensitive adhesive layer-carrying transparent conductive film or in the process of bonding it to an adherend. When the thickness is 100 μm or less, the pressure-sensitive adhesive layer-carrying transparent conductive film can have good windability before the release film 4 is peeled. If the thickness of the release film is less than 50 μm, deformations (dents) may be more likely to occur in the pressure-sensitive adhesive layer. On the other hand, a thickness of more than 100 μm is not particularly advantageous and not preferred in view of the processability of the pressure-sensitive adhesive layer-carrying transparent conductive film. As the thickness of the film substrate of the release film 4 increases, the cost increases, and the amount of the film windable into a certain roll decreases, which is also not preferred in view of economic efficiency or productivity. The release film 4, which may be finally discarded, should be effectively used within the range described above, specifically within the range of keeping the processability of the pressure-sensitive adhesive layer-carrying transparent conductive film good.

The release film 4 preferably has a bending elastic modulus of 1,500 to 8,000 MPa, more preferably 2,000 to 5,000 MPa, even more preferably 3,000 to 4,000 MPa. The bending elastic modulus may be measured according to JIS K 7203. If the bending elastic modulus is less than 1,500 MPa, deformations (dents) may be more likely to occur in the pressure-sensitive adhesive layer, which is not preferred for the appearance. In the above range, deformations (dents) are less likely to occur in the pressure-sensitive adhesive layer, so that a good appearance is provided.

In the pressure-sensitive adhesive layer-carrying transparent conductive film of the invention, the film substrate of the release film 4 and the transparent plastic film substrate 1 are preferably made of the same type of materials. A polyester-based resin, in particular, polyethylene terephthalate, is preferably used as a material to form each film.

The pressure-sensitive adhesive layer-carrying transparent conductive film of the invention preferably has a curl of 25 mm or less, more preferably 10 mm or less, after being heated at 140° C. for 1.5 hours in a size of 100 mm×100 mm. In addition, it preferably has a thermal shrinkage percentage of 1.5% or less in each of MD and TD, after being heated under the same conditions. The curl is the average of the distances between the respective four corners of the pressure-sensitive adhesive layer-carrying transparent conductive film and a flat plate, which is determined after the pressure-sensitive adhesive layer-carrying transparent conductive film is heated and then allowed to stand in a concave shape on the flat plate at 23° C. for 3 hours. As described above, the pressure-sensitive adhesive layer-carrying transparent conductive film of the invention has a relatively small curl after heating and good processability. For example, such a curl-resistant, pressure-sensitive adhesive layer-carrying transparent conductive film can be obtained by selecting the same type of materials for the film substrate of the release film and for the transparent plastic film substrate.

The pressure-sensitive adhesive layer-carrying transparent conductive film of the invention may be produced by any method capable of forming the structure described above. A general production method may include forming the transparent conductive thin film 2 (and the undercoat layer 5 in some cases) on one side of the transparent plastic film substrate 1 to form the transparent conductive laminate 10 and then forming the pressure-sensitive adhesive layer 3 on the other side of the transparent plastic film substrate 1. The pressure-sensitive adhesive layer 3 may be formed directly on the transparent plastic film substrate 1. Alternatively, the pressure-sensitive adhesive layer 3 may be formed on the release film 4 and then attached to the transparent plastic film substrate 1. The latter method is more advantageous in view of productivity, because it allows continuous production of the pressure-sensitive adhesive layer 3, when a roll of the transparent plastic film substrate 1 is used.

The invention is more specifically described with use of examples below. It will be understood that the invention is not limited to the examples below without departing from the gist of the invention.

Thickness of Each Layer

The thickness of each layer with a thickness of 1 μm or more, such as a transparent plastic film substrate, was measured with a microgauge type thickness gauge manufactured by Mitutoyo Corporation. The thickness of a layer of which thickness was difficult to directly measure, such as a pressure-sensitive adhesive layer, was calculated by subtracting the thickness of a substrate from the measured total thickness of the substrate and the layer formed thereon.

The thickness of each of an undercoat layer and an ITO film was calculated using an instantaneous multichannel photodetector system MCPD-2000 (trade name) manufactured by Otsuka Electronics Co., Ltd., based on the waveform data of the resulting interference spectrum.

Total Light Transmittance

The total light transmittance was measured according to JIS K 7105. In view of transparency, the pressure-sensitive adhesive layer-carrying transparent conductive film of the invention preferably has a total light transmittance of 80% or more, more preferably 85% or more, when it does not have any release film.

Surface Resistance

The surface resistance (Ω/square) was measured using Lowresta Resistance Meter manufactured by Mitsubishi Chemical Corporation. In the pressure-sensitive adhesive layer-carrying transparent conductive film of the invention, the transparent conductive thin film, which forms a conductive surface, preferably has a surface resistance of 100 to 1,000 Ω/square, more preferably 200 to 700 Ω/square. Particularly when it is used for touch panels, the surface resistance is preferably not so low, in view of power consumption.

### Example 1

### Formation of Undercoat Layer

A 25 μm-thick polyethylene terephthalate film (hereinafter referred to as “PET film”), on one side of which a migration preventing layer (1 μm thick, made from a urethane acrylic-based ultraviolet-curable resin) was provided, was used as a transparent plastic film substrate. The PET film used had a thermal shrinkage percentage of 0.5% in the MD direction. A 180 nm-thick first undercoat layer was formed on the other side of the film substrate using a thermosetting resin composed of a melamine resin, an alkyd resin and an organosilane condensate (2:2:1 in weight ratio). SiO₂ was then vacuum-deposited on the first undercoat layer by electron-beam heating at a degree of vacuum of 1.33×10⁻² to 2.67×10⁻² Pa to form a 40 nm-thick second undercoat layer (SiO₂ film).

Formation of Transparent Conductive Thin Film

A 20 nm-thick ITO film was then formed on the second undercoat layer by a reactive sputtering method in a 5.33×10⁻² Pa atmosphere of 80% argon gas and 20% oxygen gas using a material of 95% by weight of indium oxide and 5% by weight of tin oxide, so that a transparent conductive laminate was obtained. The ITO film was amorphous. Part of the resulting transparent conductive laminate was sampled and measured for thermal shrinkage percentage in the MD direction, and as a result, it was 0.5%. The thickness (total thickness) of the transparent conductive laminate was 26.24 μm.

### Preparation of Pressure-Sensitive Adhesive Layer-Carrying Transparent Conductive Film

A 75 μm-thick PET film, on one side of which a migration preventing layer (1 μm thick, made from a urethane acrylic-based ultraviolet-curable resin) and then a silicone peeling layer (1 μm thick) were provided, was used as a release film (77 μm in total thickness). The PET film used had a thermal shrinkage percentage of 0.4% in the MD direction. The release film had a bending elastic modulus of 3,000 MPa. Part of the release film was sampled and measured for thermal shrinkage percentage in the MD direction, and as a result, it was 0.4%. A 25 μm-thick transparent acrylic-based pressure-sensitive adhesive layer with an elastic coefficient of 10 N/cm² was formed on the peeling layer. The pressure-sensitive adhesive layer was produced using a composition of 100 parts by weight of an acrylic-based copolymer of butyl acrylate, acrylic acid and vinyl acetate (100:2:5 in weight ratio) and 1 part by weight of an isocyanate crosslinking agent. The side of the transparent conductive laminate where no transparent conductive thin film was formed was bonded to the pressure-sensitive adhesive layer side, so that a pressure-sensitive adhesive layer-carrying transparent conductive film was obtained. After heated at 140° C. for 1.5 hours, the pressure-sensitive adhesive layer-carrying transparent conductive film had a curl of 5 mm as the average of the measurements at the four corners. The transparent conductive thin film had a surface resistance of 300 Ω/square. The release film was then peeled, and the total light transmittance of a laminate of a glass plate and the transparent conductive film with the pressure-sensitive adhesive layer bonded to the glass plate was measured to be 89.0%.

### Examples 2 to 5

In each of Examples 2 to 5, a pressure-sensitive adhesive layer-carrying transparent conductive film was prepared using the same process as in Example 1, except that each of the PET films for the transparent plastic film substrate and the release film was changed to the PET film having the thermal shrinkage percentage shown in Table 1, and then the curl was measured. The results are shown in Table 1.

### Comparative Examples 1 to 3

In each of Comparative Examples 1 to 3, a pressure-sensitive adhesive layer-carrying transparent conductive film was prepared using the same process as in Example 1, except that each of the PET films for the transparent plastic film substrate and the release film was changed to the PET film having the thermal shrinkage percentage shown in Table 1, and then the curl was measured. The results are shown in Table 1.

TABLE 1

| | | | | | Difference | |
|---|---|---|---|---|---|---|
| | | | | | between | |
| | | | | | thermal | |
| | Thermal shrinkage percentage of each | | | | shrinkage | |
| | layer in MD direction (%) | | | | percentages | |
| | PET film | | | | of | |
| | for | | | | transparent | |
| | transparent | PET film | | | conductive | |
| | plastic | for | Transparent | | laminate | |
| | film | release | conductive | Release | and release | |
| | substrate | film | laminate | film | film (%) | Curl (mm) |
| Example 1 | 0.5 | 0.4 | 0.5 | 0.4 | 0.1 | 5 |
| Example 2 | 0.5 | 0.3 | 0.5 | 0.3 | 0.2 | 5 |
| Example 3 | 0.5 | 0.1 | 0.5 | 0.1 | 0.4 | 10 |
| Example 4 | 0.4 | 0.5 | 0.4 | 0.5 | −0.1 | 10 |
| Example 5 | 0.3 | 0.5 | 0.3 | 0.5 | −0.2 | 23 |
| Comparative | 0.5 | 0 | 0.5 | 0 | 0.5 | 29 |
| Example 1 | | | | | | |
| Comparative | 0.1 | 0.5 | 0.1 | 0.5 | −0.4 | 30 |
| Example 2 | | | | | | |
| Comparative | 0 | 0.5 | 0 | 0.5 | −0.5 | 31 |
| Example 3 | | | | | | |

Table 1 shows that the curl was suppressed in all of Examples 1 to 5, in contrast to Comparative Examples 1 to 3.

1. A pressure-sensitive adhesive layer-carrying transparent conductive film, comprising:
an amorphous transparent conductive laminate comprising a transparent plastic film substrate and an amorphous transparent conductive thin film provided on one side of the transparent plastic film substrate;
a pressure-sensitive adhesive layer; and
a release film that is provided on another side of the transparent plastic film substrate with the pressure-sensitive adhesive layer interposed therebetween and comprises at least a film substrate, wherein
the release film is thicker than the amorphous transparent conductive laminate, and
a value obtained by subtracting the thermal shrinkage percentage of the release film in the MD direction from the thermal shrinkage percentage of the amorphous transparent conductive laminate in the MD direction is from −0.3% to 0.45%.

2. The pressure-sensitive adhesive layer-carrying transparent conductive film of claim 1, further comprising at least one undercoat layer, wherein the amorphous transparent conductive thin film is provided on one side of the transparent plastic film substrate with the at least one undercoat layer interposed therebetween.

3. The pressure-sensitive adhesive layer-carrying transparent conductive film of claim 1, wherein the amorphous transparent conductive thin film is made of a metal oxide comprising 90 to 99% by weight of indium oxide and 1 to 10% by weight of tin oxide.

4. The pressure-sensitive adhesive layer-carrying transparent conductive film of claim 1, wherein the transparent plastic film substrate has a thickness of 10 to 40 μm, and the release film has a thickness of 50 to 100 μm.

5. The pressure-sensitive adhesive layer-carrying transparent conductive film of claim 1, wherein the release film has a bending elastic modulus of 1,500 to 8,000 MPa.

6. The pressure-sensitive adhesive layer-carrying transparent conductive film of claim 1, wherein the release film comprises a peeling layer and/or a layer for preventing oligomer migration on a side where the film substrate of the release film faces the pressure-sensitive adhesive layer.

7. The pressure-sensitive adhesive layer-carrying transparent conductive film of claim 1, wherein the pressure-sensitive adhesive layer has a thickness of 5 to 50 μm.

8. The pressure-sensitive adhesive layer-carrying transparent conductive film of claim 1, wherein the pressure-sensitive adhesive layer is an acrylic-based pressure-sensitive adhesive layer.

9. The pressure-sensitive adhesive layer-carrying transparent conductive film of claim 1, wherein the film substrate of the release film and the transparent plastic film substrate are made of the same type of materials.

10. The pressure-sensitive adhesive layer-carrying transparent conductive film of claim 1, which has a curl of 25 mm or less, after being heated at 140° C. for 1.5 hours.

11. The pressure-sensitive adhesive layer-carrying transparent conductive film of claim 1, wherein the pressure-sensitive adhesive layer is used for bonding to any other substrate, after the release film is peeled.

12. The pressure-sensitive adhesive layer-carrying transparent conductive film of claim 1, wherein the amorphous transparent conductive thin film is subjected to a crystallization process, and then the crystallized transparent conductive thin film is used for bonding to any other substrate with the pressure-sensitive adhesive layer peeled from the release film.

13. A method for producing the pressure-sensitive adhesive layer-carrying transparent conductive film of claim 1, comprising the steps of:
providing an amorphous transparent conductive laminate comprising a transparent plastic film substrate and an amorphous transparent conductive thin film provided on one side of the transparent plastic film substrate; and
bonding a pressure-sensitive adhesive layer provided on a release film to another side of the transparent plastic film substrate in the amorphous transparent conductive laminate.
